(19) United States
(12) Patent Application Publication
(10) Pub. No.: US 2016/0343004 A1
(43) Pub. Date: Nov. 24, 2016

(54) PROCESS JOURNEY SENTIMENT ANALYSIS

(71) Applicant: Logic Information Systems, Inc., Bloomington, MN (US)

(72) Inventor: Robert Earl Brink, Richmond, TX (US)

(21) Appl. No.: 14/715,110

(22) Filed: May 18, 2015

(51) Int. Cl. G06Q 30/02; G06F 17/30

(52) U.S. Cl. CPC G06Q 30/0201; G06F 17/30401

(57) ABSTRACT

Systems and methods may be used for analyzing customer sentiment of one or more products or processes. Plain-text data may be acquired from a variety of sources (e.g., one or more websites) and analyzed to determine sentiment regarding one or more aspects of the product or process. The acquired plain text data may be broken into one or more phrase features that include sentiment information regarding an attribute associated with a product or an entity associated with a process. The phrase features can be individually analyzed to determine the sentiment for each of the attributes or entities. Sentiment information for each attribute or entity can be presented in an organized view allowing for easy and detailed sentiment analysis for various attributes or entities associated with a product or process. Sentiment for additional products or processes with common attributes or entities may be predicted using the analyzed plain text data.

### BACKGROUND

Basic sentiment analysis for analyzing consumer sentiment of a product is an emerging tool in business analysis. Many systems employ a user-rating process, by which users wishing to provide reviews for various products or aspects of a product rate such aspects on a predefined scale, such as one to five stars. This data can be easily captured and analyzed for determining customer sentiment of a product.

Some systems are beginning to perform natural language processing (NLP) on text-based review. Such systems can be configured to score products based on a simple analysis of text-based reviews. For example, a system might search through a paragraph of user-submitted text in a review section of a product page, and compare language in the text to a dictionary of predetermined positive/negative sentiments. The product is then scored based on the occurrences of such sentiments, for example, positive points for positive sentiment, native pointes for negative sentiment (e.g., occurrence of “happy”=+1 point, occurrence of “sad”=−1 point). In such a scoring system, a higher score generally corresponds to a more highly rated product.

However, such analyses are limited in their scope. For instance, without context, reviews such as, “I was not happy with . . . ” or “this product is good for nothing,” might receive a score of +1 point despite negative sentiment. NLP may help correct some of these errors, but systems are limited when analyzing plain text data. In other examples, a review reading “the size of the product is good but the color the product is bad” might yield misleading results.

Further, such reviews are generally applied to a single product, which subsequently receives a score which can be compared with scores of other products. However, such analysis may represent an incomplete analysis of the sentiment with a product or a process. For example, generating a single score to determine a sentiment of a product does not provide an indication of why the sentiment score is as determined. As such, there is little ability for a user to improve the sentiment of a product or process simply based on a score.

### SUMMARY

Aspects of the present invention include a system configured to acquire and analyze plain text data to perform sentiment analysis regarding a variety of entities associated with a process. Such a system can include a variety of components configured to perform various functions associated with the generation of the sentiment analysis.

The system can include an acquisition manager configured to acquire plain text data that is to be analyzed for sentiment analysis. The system can further include an entity manager in communication with and configured to receive the acquired plain text data from the acquisition manager. The entity manager can comprise a database defining various entities associated with a process that may be found within the acquired plain text data. Such entities can include, for example, steps of the process, actors performing steps of the process, items being acted upon during steps of the process, or other dimensions associated with the process. Similarly, the entity manager may include entity information regarding one or more attributes related to one or more products.

Embodiments of the system can include a language manager configured to analyze the plain text data acquired by the acquisition manager. In some examples, the language manager analyzes the plain text data in view of attribute or entity information stored in the entity manager. In some embodiments, the language manager may perform any combination of: natural language processing (NLP) on the acquired plain text data, assigning customized grammar to the acquired plain text data, and isolating fragments of the plain text data for separate analysis. The fragments may include a single sentiment and a single attribute or entity associated with a product or process.

Some embodiments of the system include an event manager in communication with the language manager. The event manager can receive the isolated fragments identified by the language manager and assign each fragment with a single entity of the process or attribute of a product. In some examples, the event manager is in communication with the entity manager for determining entities associated with a process.

The system can include a process manager for assigning the associated attributes or entities and text fragments to one or more products or processes. In some examples, the process manager can be configured to perform sentiment analysis on the acquired plain text data based on received associated attributes or entities and text fragments from the event manager.

The system may be configured to generate graphical representation of sentiment associated with each attribute of a product or step in a process. The graphical representation may include a variety of information represented by one or more graphics. In some examples, the graphical representation can include a process- or product-identifying graphic and two or more entity- or attribute-identifying graphics associated with the process- or product-identifying graphic. Each of the entity- or attribute-identifying graphics may include information regarding the overall sentiment associated with the associated entity or attribute from the plain text data, as well as the strength of the sentiment.

### BRIEF DESCRIPTION OF THE DRAWINGS

FIG. 1 is a high level block diagram of an exemplary process journey sentiment analysis system.

FIG. 2 is a diagram illustrating exemplary operation of an acquisition manager.

FIGS. 3A and 3B are diagrams illustrating exemplary operation of an entity manager.

FIG. 4 is a diagram illustrating exemplary operation of a language manager.

FIG. 5 is a diagram illustrating exemplary operation of an event manager.

FIG. 6 is a diagram illustrating exemplary operation of a process manager.

FIG. 7A is an exemplary interface providing sentiment information regarding a variety of entities associated with a process.

FIG. 7B is an exemplary view of a first entity-identifying graphic.

FIG. 8A is an exemplary interface providing sentiment information regarding a variety of attributes associated with a product.

FIG. 8B is an exemplary view of a first attribute-identifying graphic.

### DETAILED DESCRIPTION

Embodiments of the invention can include a system configured to acquire and analyze plain text data to perform sentiment analysis regarding a variety of attributes or entities associated with a product or process of interest. Such a system can include a variety of components configured to perform various functions associated with the generation of the sentiment analysis.

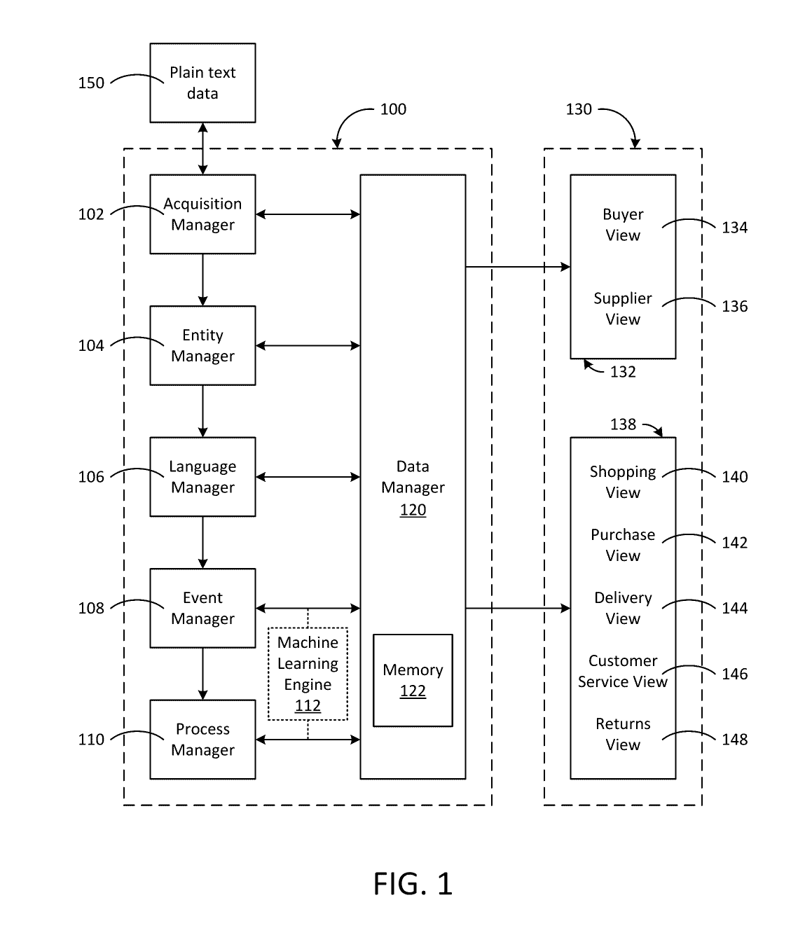

FIG. 1 is a high level block diagram of an exemplary process journey sentiment analysis system. The system 100 of FIG. 1 includes an acquisition manager 102 configured to acquire plain text data 150 that is to be analyzed for sentiment analysis. The acquisition manager 102 can acquire the plain text data 150 from any number of data sources, such as the internet. The acquisition manager 102 can include instructions designating where to search for the plain text data, for example, one or more specific websites. In some such examples, the acquisition manager 102 is configured to manager web crawlers for searching various areas on the internet for appropriate plain text data 150.

The system 100 can further include an entity manager 104 in communication with and configured to receive the acquired plain text data 150 from the acquisition manager 102. The entity manager 104 can comprise a database defining various entities associated with a process of interest that may be found within the acquired plain text data 150. Such entities can include, for example, steps of the process, actors performing steps of the process, or items being acted upon during steps of the process. Additionally, in some instances, entities can have associated attributes describing the entity. For example, attributes for an item might include style and color, an attribute for a process actor might be a location of the actor, and an attribute for a process might be an intended benefactor of the process. Many such examples are possible.

The system 100 of FIG. 1 includes a language manager 106 configured to analyze the plain text data 150 acquired by the acquisition manager 102. In some examples, the language manager 106 analyzes the plain text data 150 in view of entity information stored in the entity manager 104. The language manager 106 can be configured to isolate fragments of the plain text data for individual analysis. In some examples, the language manager 106 analyzes the plain text data 150 based on natural language processing (NLP) in order to identify and isolate such fragments for analysis.

The system 100 further includes an event manager 108 in communication with the language manager 106. The event manager 108 can receive the isolated fragments identified by the language manager 106 and assign each fragment with a single entity of the process. In some examples, the event manager 108 is in communication with the entity manager 104 for determining entities associated with a process.

The system 100 can include a process manager 110 for assigning the associated entities and text fragments to one or more processes of interest. FIG. 6 is a diagram illustrating exemplary operation of a process manager 110. In some examples, the process manager 110 can be configured to perform sentiment analysis on the acquired plain text data based on received associated entities and text fragments from the event manager 108.

In some embodiments, the system 100 can include a machine learning engine 112 configured to learn and execute various processes that can be performed during system 100 operation. As shown in the exemplary embodiment of FIG. 1, machine learning engine 112 can be in communication with at least one of event manager 108 and process manager 110. The machine learning engine 112 can execute any of a variety of known machine learning techniques for use with event manager 108 and process manager 110. In some embodiments, the machine learning engine 112 can analyze structured language data (e.g., from an NLP analysis) and use such data to generate rules and models to further analyze language according to a variety of examples. That is, the machine learning engine 112 can be ‘taught’ to process data by providing data to the engine along with examples of the desired analysis of the data. The engine can create rules and models to define various properties of the plain text data based on the ‘answers’ provided to it during the learning process.

In some examples, the machine learning engine 112 can be tested for accuracy, and the accuracy score can be compared to a threshold. If the accuracy score does not meet the threshold, another machine learning process can be attempted. In other examples, if the accuracy score threshold is not met, the machine learning engine 112 can be provided with more examples and data in order to generate more rules and models until a sufficient accuracy score is achieved.

In some examples, the same machine learning process is used with event manager 108 and process manager 110. In other examples, different machine processes are used. In some embodiments, the machine learning engine 112 can employ a plurality of machine learning processes in relation to operation of at least one of the event manager 108 and the process manager 110. The quality of the machine learning process for a give operation can be analyzed, for example by a user via an interface, the machine learning engine 112, or other system 100 component. For example, an accuracy score can be determined by a user assessing the results of the machine learning engine 112. Accuracy scores of a variety of machine learning processes can be compared, and the most appropriate machine learning process can be determined. The most accurate process can be selected and employed for future use. In some examples, the functionality of the machine learning engine 112 is performed by separate machine learning engines operating within various managers, such as within the event manager 108 or the process manager 110.

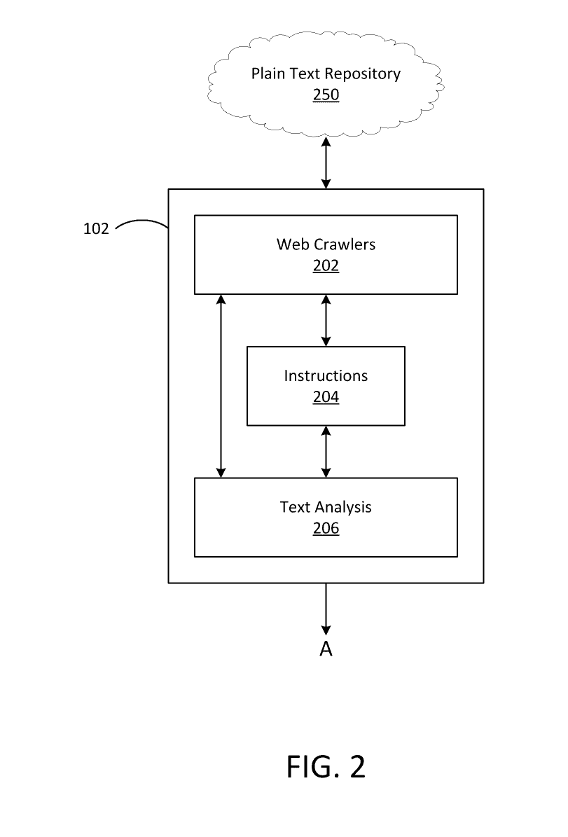

FIGS. 2-6 illustrate more detailed features of aspects of the system 100. FIG. 2 is a diagram illustrating exemplary operation of an acquisition manager 102. The acquisition manager 102 can manage the acquisition of plain text data from a plain text repository 250. In some examples, the acquisition manager 102 manages web crawlers 202 configured to acquire plain text data from the internet, though it will be appreciated that other sources of plain text data can be used such as an electronic text document accessible by the system 100. The acquisition manager 102 can include or otherwise receive instructions 204 directing the acquisition manager 102 to a specific plain text repository 250, such as a particular website or group of websites. For example, the acquisition manager 102 can be directed to acquire plain text data from retail websites, social media websites and company-specific websites.

The acquisition manager 102 can perform text analysis 206 of the plain text data available at the plain text repository 250 and extract relevant plain text data from the repository 250 according to instructions 204. For example, the acquisition manager 102 can receive or include instructions 204 directing the acquisition manager 102 to extract plain text data associated with a particular product, brand of product, company, process, or other defined aspect associated with the process of interest. In some examples, the plain text repository 250 can include at least one particular internet domain directed specifically toward receiving plain text data associated with a particular product, brand, etc. In some such examples, the acquisition manager 102 can extract all plain text data received from the repository 250 without first requiring text analysis 206 to determine relevant plain text data.

In general, the acquisition manager 102 can search a plain text repository 250 via web crawlers 202 (or any other appropriate searching mechanisms), and perform text analysis 206 on the plain text data found in the plain text repository 250 according to instructions 204. Plain text data considered relevant to a process of interest based on instructions 204 and text analysis 206 can be extracted by the acquisition manager 102 at A as shown in FIG. 2. If the system 100 is to be used for analysis of a different process of interest, the acquisition manager 102 can be directed to a different plain text repository 250 according to instructions 204 based on the new process of interest.

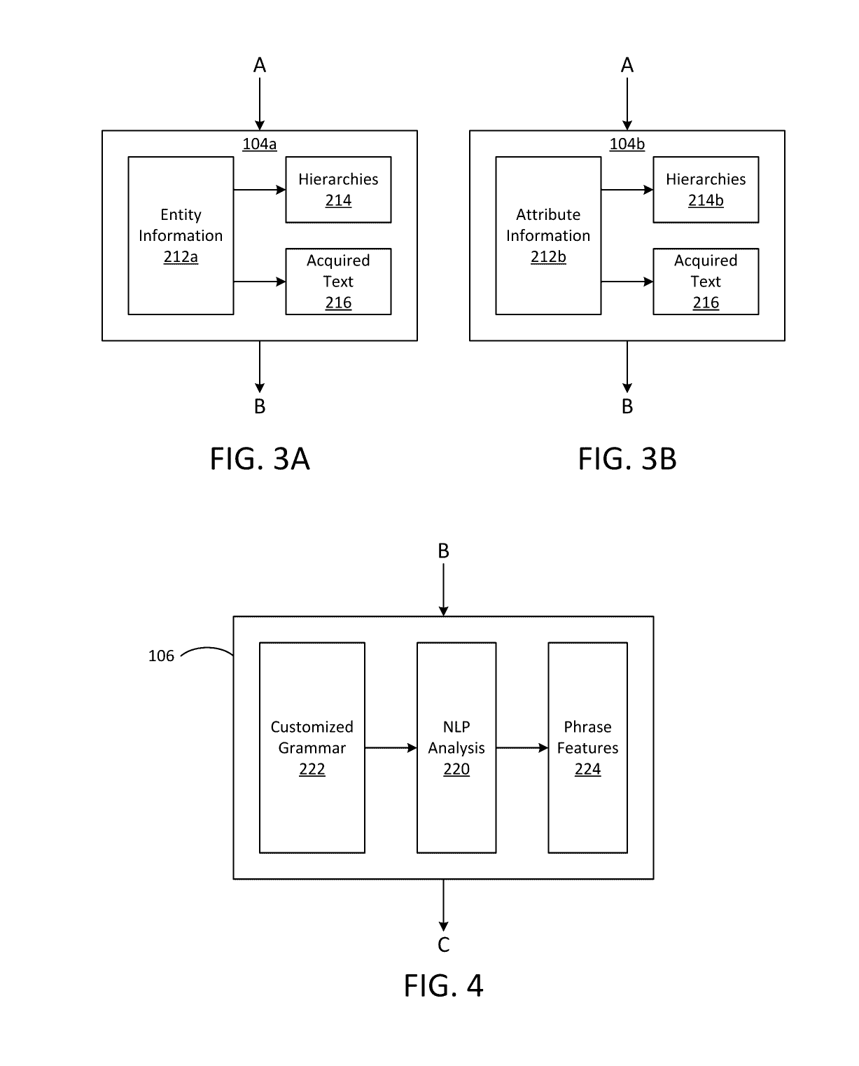

As shown in FIG. 1, the acquisition manager 102 can be in communication with an entity manager 104. FIG. 3A is a diagram illustrating exemplary operation of an entity manager 104a. Entity manager 104a can receive relevant extracted plain text data from the acquisition manager 102, shown at A in FIG. 3A. The entity manager 104a can include entity information 212a regarding a variety of entities associated with a process of interest, such as steps in the process, actors in the process, or items acted upon in the process. For instance, entity information can include various descriptions, categories, features, properties, or any other aspect associated with such entities. Such entity information 212a can be arranged into hierarchies 214a defined in the entity manager 104a according to relationships between aspects captured by entity information 212a.

In some examples, entity information 212a can include attributes associated with one or more entities of a process. Attributes can similarly be associated with products of interest. In some examples, products of interest are entities included in a process of interest (e.g., the product for sale in the process of purchasing a product). Thus, entity manager 104 may include information regarding attributes in much the same way as described above regarding entities. FIG. 3B is a block diagram of an entity manager managing attributes in a similar way as entities are described with respect to FIG. 3A. As shown, attributes can be similarly arranged into hierarchies 214b as described regarding entities. In some embodiments, attributes and entities can be included in overlapping hierarchies. For instance, a process of interest at the top of a hierarchy can include a variety of entities at a lower level of a hierarchy. Each entity can include a variety of associated attributes at a still lower level of the hierarchy. In other examples, a hierarchy may exist wherein the highest level includes a product of interest, and wherein various attributes of the product are at a lower level of the hierarchy. In general, a product of interest can be an entity associated with a process of interest, or can stand alone as a product to be analyzed.

The entity manager 104a can assign entity information 212a to the acquired plain text data 216. For example, the entity manager 104a can determine that the plain text data is associated with at least one particular entity based on aspects of the entities stored in entity information 212a and the acquired text 216. Similarly, entity manager 104b of FIG. 3B can determine that plain text data is associated with at least one attribute of an entity or product of interest stored in entity information 212a or attributes information 212b.

Entity manager 104b can manage attribute information 212b, for example, associated with a product of interest or a product associated a process of interest. In some examples, the entity manager 104b can manage attribute information that is a subset of entity information 212a. For instance, the entity manager 104b can assign attribute information 242b to hierarchies 214b and to acquired plain text data 214 associated with attributes of products, which may be entities in a process of interest. In some examples, attribute information 212b can include, for example, a variety of descriptive or other information-containing categories associated with one or more products, such as a type, brand, color, price, durability, reliability, or any other of a variety of attributes. In some such embodiments, attributes of a product can be handled analogously to entities of a process.

Attributes can similarly be arranged into hierarchies. Levels of hierarchies can, for example, include a variety of attributes associated with a product of interest. For instance, a brand of product may include several different types of that product. Each type may be associated with a separate category. Thus, a hierarchy having the brand on a highest level, categories of products on a lower level, and types of products within each hierarchy at a still lower level. In an exemplary embodiment, a retailer specializing in shoes might have a department for women's shoes, a department for men's shoes and a department for children's shoes. Each of those departments might be subdivided into sporting shoes, dress shoes and casual shoes. Thus, a hierarchy can be adapted to an inventory structure of the retailer.

As described with regard to FIGS. 3A and 3B, entity information 212a and attribute information 212b may be treated similarly by entity manager 104a/104b. In general, a single entity manager 104 may include and manage information regarding entities of a process (e.g., entity information 212a) as well as attributes of entities or products (e.g., attribute information 212b), apply such information to acquired text 216, and arrange entities and/or attributes into common, overlapping, or disjoint hierarchies (e.g., 214a, 214b). Accordingly, as generally used herein, “entity manager” (e.g., 104), “entity information” (e.g., 212), “hierarchies” (214), and the like may be used to refer to entities and attributes alike unless otherwise specified. Similarly, treatments of various processes of interest having one or more associated entities may apply to treatments of products of interest having one or more associated attributes.

In some examples, the entity manager 104 is programmed to assign entity information 212 to acquired text 216 based on predefined criteria. For example, the entity manager 104 can search for the items stored in entity information 212 or other predefined words or phrases in the acquired text 216, and assign the appropriate entity information 212 to the particular words of phrases. That is, in some embodiments, the entity manager 104 is trained to search for certain features in the acquired text 216 to which to assign certain entity information 212. In the case of a new process of interest, the entity manager 104 can be configured with different entity information 212 associated with the new process of interest, and can assign the different entity information 212 similarly.

In general, plain text data having associated entity information can be generated by the entity manager 104 at B. As shown in FIG. 1, the system 100 can include a language manager 106 in communication with the entity manager. FIG. 4 is a diagram illustrating exemplary operation of a language manager 106. As shown in FIG. 4, a language manager 106 can be configured to receive and analyze the acquired plain text data, such as the plain text data at B. In some examples, the language manager is configured to perform natural language processing (NLP) 220 on the acquired plain text data. A variety of NLP techniques are known and can be utilized by the language processor in analyzing the acquired plain text data. In some embodiments, the language manager 106 can perform NLP by assigning customized grammar 222 to the acquired plain text data. For instance, in some examples, the language manager 106 can analyze plain text data (e.g., a product review) based on patterns of language typical of phrases expressing sentiment (e.g., typical phrases in a product review). The language manager 106 can determine parts of speech in the acquired plain text data and identify clauses based at least in part on such determined parts of speech.

Additionally or alternatively, the language manager 106 can perform NLP analysis to identify phrase features 224 in the plain text data. Phrase features 224 can include isolated fragments of the plain text data communicating a specific idea. In some examples, phrase features 224 can include a minimum amount of plain text data to communicate a single idea. The single idea can include, for example, a sentiment and a single entity or an attribute of an entity associated with that sentiment. In some examples, the language manager 106 associates an attribute with an entity, and generates a phrase feature including the entity, the attribute of the entity, and sentiment associated with at least one of the entity and the attribute. The language manager 106 can be configured to recognize grammar structures that identify such sentence fragments typical of acquired plain text data (e.g., product reviews) that contain meaningful information.

In some examples, the language manager 106 can generate phrase features 224 including sentiments and steps of a process, sentiment and actors in a process, sentiment and items acted upon in a process, or sentiment and an attribute of any of such entities. In some such examples, the language manager 106 can identify dimensions of a process separate from steps in the process, such as a buyer satisfaction, a product quality, or the effectiveness of a service. Thus, the language manager 106 can receive acquired plain text data having associated entity information at B, and break such plain text data into single fragments demonstrating sentiment or other ideas regarding an associated entity or attribute of such an entity at C.

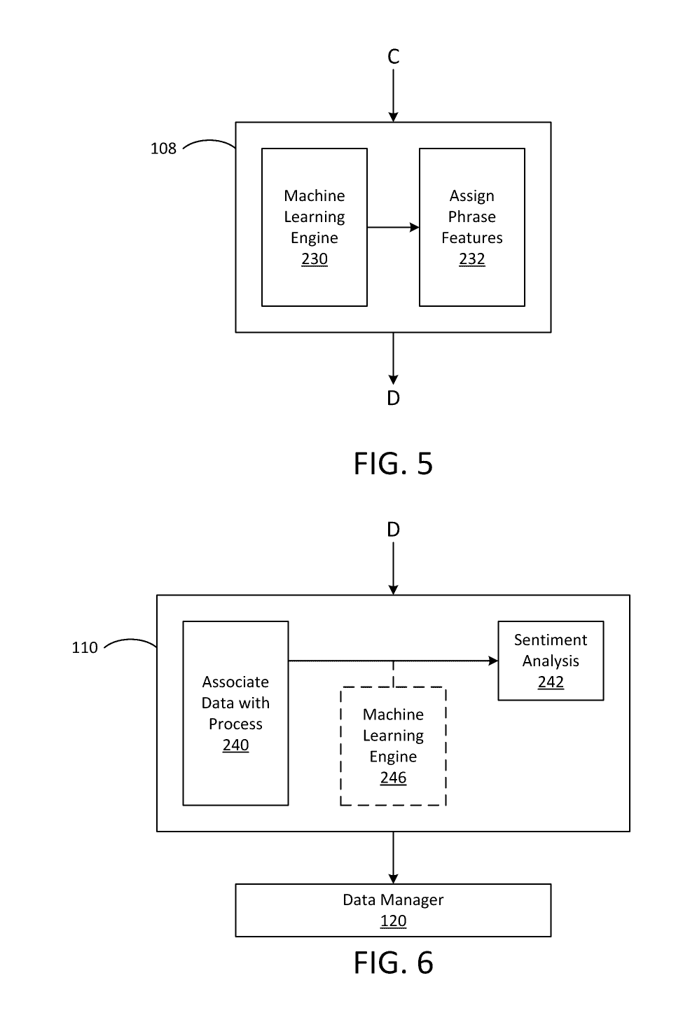

As shown in FIG. 1, the language manager 106 can be communication with an event manager 108. FIG. 5 is a diagram illustrating exemplary operation of an event manager 108. The event manager 108 can receive natural-language-processed plain text data from the language manager 106 at C. The received plain text data can include assigned entity information 212 from the entity manager 104 as well as phrase features 224 including a single entity or attribute associated with an entity and sentiment from the language manager 106. The event manager 108 can be configured to separate phrase features 224 having entities or attributes and sentiment into useful categories. For instance, in some embodiments, the event manager 108 can be configured to assign 232 each of the generated phrase features 224 to a single entity or attribute associated with a product or process of interest. In some examples, the entity or attribute to which each phrase feature is assigned 232 is included in the entity information 212 assigned to the acquired text 216. The event manager 108 can output the associated phrase features 224 and associated entities and attributes at D.

The event manager 108 can include a machine learning engine 230. The machine learning engine 230 can be configured to receive examples for assigning generated phrase features to single entities, attributes, or other dimensions associated with one or more processes. In some examples, the machine learning engine 230 can be taught to determine the subject of a sentiment expressed in a phrase feature. For instance, a phrase feature received from the language manager may include an entity, an attribute of the entity, and a sentiment. In some such examples, the machine learning engine 230 can be configured to determine with which of the entity or the attribute the sentiment is associated. Many possible machine learning techniques are known and are possible for use with the event manager 108.

In some examples, the machine learning engine 230 can receive one or more examples of performing processes to be executed by the event manager 108, and can perform multiple different machine learning techniques to learn to perform such processes. The machine learning engine 230 can be configured to employ the best of the multiple attempted machine learning processes. In some examples, the best machine learning process can be determined and selected manually by a user, or automatically by the machine learning engine 230 or other system 100 component. The machine learning engine 230 can be continually updated as more processes, process entities, attributes, or other items for which sentiment analysis is desired are defined.

In various examples, machine learning engine 230 can employ any number of machine learning techniques. In some examples, multiple machine learning techniques can be attempted, with the best of the machine learning techniques being identified and implemented in future machine learning processes. The machine learning engine 230 can be continually updated as new processes, process entities, entity attributes, or other items (e.g., products) are defined for sentiment analysis, or as new useful categories are defined.

As described with respect to machine learning engines 230, machine learning engines of the system 100 can generally be taught exemplary procedures according to operation of various components (e.g., language manager 106, event manager 108). The machine learning engine can learn to process and perform functions based on the received examples, and can be used for performing such processes in the future. Any of a variety of known machine learning techniques may be used, such as, for example, the Naive Bayes classifier.

Once phrase features are assigned 232 to entities or attributes, the system 100 can generate an overview of sentiment analysis regarding at least one process or product of interest. As shown in FIG. 1, the system 100 can include a process manager 110 for receiving the phrase features and associated entities and attributes at D. The process manager can accumulate such data, and assign each entity or attribute and the associated phrase feature of the acquired plain text data to corresponding ones of the at least one product or process 240.

In some examples, the process manager can be configured to perform sentiment analysis 242 associated with the received data. Sentiment analysis 242 can be performed according to a variety of processes. For example, sentiment analysis 242 can be performed regarding each individual entity or attribute from entity information 212 associated with the plain text data. In another example, sentiment analysis 242 can be performed regarding a category of entities or attributes, for instance, as defined by at least one hierarchy 214. Accordingly, some such categories of entities or attributes can be defined according to entity information 212 in the entity manager 104. In general, the process manager can perform sentiment analysis 242 on any entity, attribute, or categories thereof from the acquired text 216 having associated phrase features 224.

As shown, in some examples, process manager 110 can include a machine learning engine 246 such as described above with respect to machine learning engine 230 of the event manager 108. Machine learning engine 246 can be taught by example ways to analyze sentiment associated with phrase features, and therefore, sentient associated with various attributes and entities corresponding to such phrase features. Machine learning engine 246 can be constructed, taught, and selected in ways similar to those described above with respect to machine learning engine 230.

As illustrated in FIG. 1, the system 100 can include a data manager 120 in communication with at least one of the acquisition manager 102, entity manager 104, language manager 106, event manager 108, and process manager 110. In some examples, the data manager 120 can include a memory 122 for storing a variety of information. In some examples, the data manager 120 can store data or instructions 204 for acquisition parameters and preferences for the acquisition manager 102. For instance, the data manager 120 can include information directing the acquisition manager 102 where to search for plain text data (e.g., can define the plain text repository 250). The data manager 120 can additionally or alternatively store entity information 212 for use with entity manager 104, including product or other entity or attribute definitions and hierarchies 214 into which entities and attributes can be arranged.

In some embodiments, the data manager 120 can store language parameters and preferences for use with the language manager 106. Such language parameters and preferences can include at least one of information for performing NLP analysis 220, or information for generating phrase features 224 or customized grammar 222 from the plain text data. In some examples, the data manager 120 can include process or event definitions for use by the process manager 110 for assigning various attributes to entities or various entities to processes.

The data manager 120 can additionally or alternatively provide temporary data storage for at least one component of system 100. For instance, in some examples, the acquisition manager 102 can acquire plain text data from the plain text repository 250, perform text analysis 206, and store analyzed plain text data in memory 122 where it can be accessed by the entity manager 104. In general, any of A, B, C, D from FIGS. 2-6 can represent a location in memory 122 of data manager 120.

In some examples, the data manager 120 can further provide security, integrity, and administration of the data resources. That is, the data manager 120 can manage access to stored data and permissions for adjustment of parameters for acquiring and analyzing plain text data. Accordingly, the ability to access or adjust various system data and parameters can be customized on a system-by-system basis. As shown in FIG. 1, in some examples, the data manager 120 can provide or communicate information to at least one interface 130 for providing access to such data and parameters.

In some examples, the interface 130 of the data manager 120 can provide a variety of views associated with various process actors 132 according to a process of interest. Process actors 132 can include, for example, customers, retailers, customer service representatives, product suppliers, a product delivery company, etc. As each actor in a process may experience different entities or attributes associated with a process or product of interest, the data manager 120 can provide an interface including a specific view related to such process actors. For example, in the illustrated embodiment, the data manager 120 can initiate a buyer view 134 and a supplier view. The buyer view 134 can include sentiment information regarding a variety of entities or attributes associated with a buyer's role in a process or product if interest. Similarly, the supplier view 136 can include sentiment information regarding a variety of entities or attributes associated with a supplier's role in a process or product if interest. It will be appreciated that process actors 132 for which distinct views are defined are not limited to buyers and suppliers. In general, such a view generated via the data manager 120 can be tailored for any person or group of people associated with a process or product of interest.

Additionally or alternatively, the data manager 120 can provide views associated with a variety of process steps 138. For example, as shown in FIG. 1, the data manager 120 can generate various views, such as a shopping view 140, a purchase view 142, a delivery view 144, a customer service view 146, and a returns view 148. Such views can include information regarding sentiment of a variety of entities or attributes associated with the process steps 138 or entities associated with such steps, including, in some examples, the steps themselves.

In some examples, views such as those described related to process actors and process steps can include hierarchy information (e.g., 214) associated with a particular actor or step. For example, one step in a process of interest may include a plurality of sub-steps or associated entities or attributes in a lower tier of a hierarchy 214. A process-step 138 view regarding such a step may include sentiment information regarding any number of the associated sub-steps, attributes or entities at lower levels of a hierarchy 214. In some examples, a variety of process steps, such as those listed in 138, can be included in one or of a buyer view 134 or a supplier view 136. Similarly, process actors, such as those listed in 132, can be included in any views associated with process steps 138. In general, the data manager 120 can receive entity information 212 from the entity manager 104 to associate various process entities and attributes for generating at least one view available via the interface 130.

In some embodiments, the data manager 120 can support a customized view in which a user can select which entities, attributes, or products or processes of interest are used to generate the view. Additionally or alternatively, in some examples, certain users are provided access to only a subset of available views, such as views providing actor—132 or step—138 based views related to the user's role in the process. For example, data manager 120 may include a catalog of plain text data arranged according to many processes of interest and be configured to generate a plurality of views demonstrating sentiment of such processes or entities or attributes associated with such processes. A user may log in to a server to access this data using individual login information, and may subsequently access the subset of views associated with that user. Such exemplary users may be a supplier or a buyer of a particular product or service, for instance.

In some embodiments, a view can include a graphic generated to quickly convey a variety of sentiment information regarding a process of interest. In some examples, the graphic can include a dynamically-generated process-identifying graphic identifying the process of interest. In some examples, the process-identifying graphic indicates an entire process. In some cases, a process-identifying graphic can identify a selected sub-process or step or other entity of a process of interest. In some embodiments, a view provides a user an opportunity to select a process of interest or to select a step or other entity associated with the process from an established hierarchy including the process at one level of the hierarchy and the associated steps or other associated entities at a separate level of the hierarchy.

A view presented via the interface 130 can further include at least one entity-identifying graphic, each entity-identifying graphic being associated with at least one entity associated with the process in the process-identifying graphic. The at least one entity-identifying graphic can indicate a variety of information regarding the entity to a user via the interface 130. For example, in various embodiments, an exemplary entity-identifying graphic can indicate to the user at least one of the relative sentiment regarding that entity gathered from the acquired plain text data, the relative strength of the sentiment, and the number of generated phrase features identified as corresponding to the entity. In various embodiments, a view presented via the interface 130 can include any number of entity-identifying graphics representative of such information for a corresponding number of entities associated with the process.

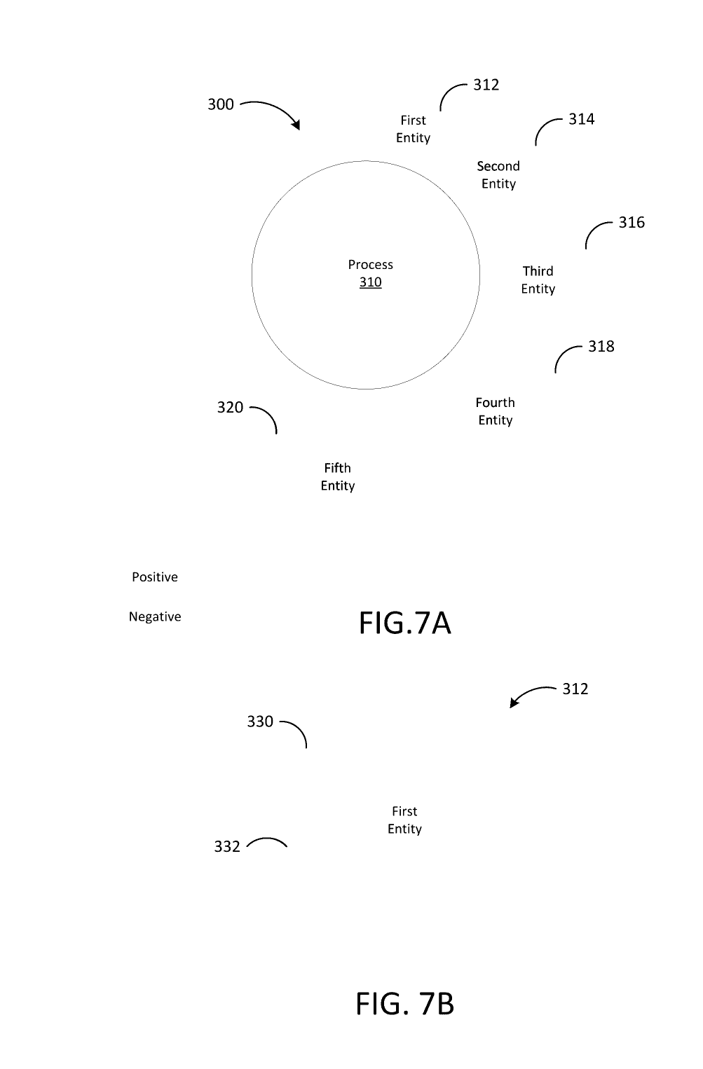

FIG. 7A is an exemplary process view providing sentiment information regarding a variety of entities associated with a process. As shown, the view 300 includes a process-identifying graphic 310 indicating the process. In the illustrated embodiment, the process-identifying graphic is surrounded by a plurality of entity-identifying graphics 312-320, each entity-identifying graphic 312-320 being representative of a single entity associated with the process identified by the process-identifying graphic 310. As described, exemplary entities can include any of: steps of the process, actors performing steps of the process, items being acted upon during steps of the process, or other dimensions associated with the process. While in the illustrated view 300, the process has five represented associated entities, it will be appreciated that in some embodiments, any number of entity-identifying graphics 312-320 can be included. In some embodiments, a user can select a customizable subset of available entities associate with the process for which to include an entity-identifying graphic in the view. Accordingly, the various entity-identifying graphics displayed on the view can be dynamically updated according to user preferences.

Each entity-identifying graphic 312-320 of FIG. 7A includes a first area and second area, the first area shown as being white while the second area is shaded. The first area of each entity-identifying graphic 312-230 indicates the relative amount of positive sentiment associated with that entity while the second area is indicative of the relative amount of negative sentiment associated with that entity. For example, as shown in FIG. 7B, which is an exemplary view of the first entity-identifying graphic 312, the first entity-identifying graphic 312 includes a relatively large first area 330 (unshaded) compared to a relatively small second area 332 (shaded), indicating a relatively large amount of positive sentiment compared to the amount of negative sentiment associated with the first entity 312 of the process 310. In some examples the relative size of the first area 330 to the second area 332 corresponds to the relative number of phrase features regarding the first entity 312 and having positive sentiment compared to the relative number of phrase features regarding the first entity 312 and having negative sentiment. In some examples, the system (or a user) can determine which of the first area 330 and the second area 332 is larger, and accordingly determine an overall sentiment (e.g., positive or negative) associated with the entity.

For example, a portion of plain text data may include three phrase features regarding an entity, one of which is associated with positive sentiment and two of which are associated with negative sentiment. An exemplary representative entity-identifying graphic 312-320 according to some embodiments would include a first area (⅓ of the entity-identifying graphic) that is half the size of the second area (⅔ of the entity-identifying graphic).

In some examples, the view 300 can include information representative of the overall number of phrase features contribute to the sentiment representation of an entity-identifying graphic 312-320. For instance, the relative size of an entity-identifying graphic 312-320 can be indicative of the number of analyzed phrase features associated with a particular entity. In the example of FIG. 7A, it is immediately evident to a user viewing the view 300 that there are more phrase features expressing sentiment regarding the fifth entity 320 than there are phrase features expressing sentiment regarding the first entity 312. Such information can inform the user about which entities contributors of plain text data to the plain text repository 250 tend to express sentiment, potentially indicating which entities contributors feel most strongly about.

In some examples, the view such as that shown in FIGS. 7A-7B can be customizable in a variety of ways. For example, in various embodiments, a user may be able to place restrictions on which plain text data is analyzed in order to generate the view 300, such as a subset of repositories 250 from which the plain text data is acquired or how recently the plain text data has been created. In some embodiments, users can select which process (e.g., 310) and which entities (e.g., 312-320) are to be included in the view 300. A variety of other customizable options can be available to a user, including display techniques such as shapes or colors of various graphics and areas within the graphics. It will be appreciated that other shapes, sizes, fill patterns, and other display parameters may be substituted for the exemplary representation shown in FIG. 7A without departing from the scope of the invention.

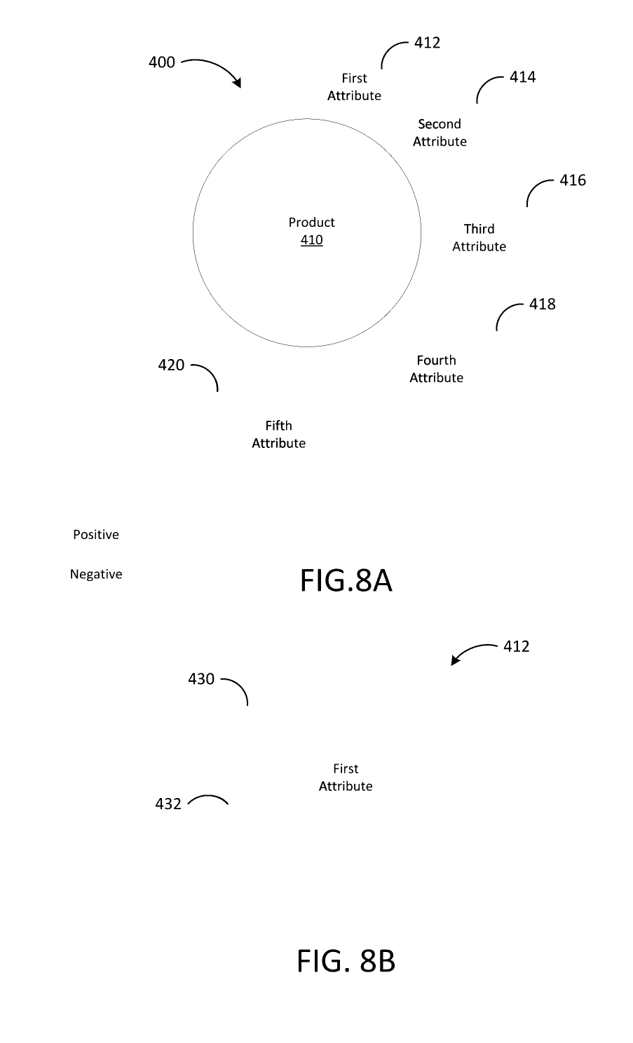

In general, the processes described regarding a process view such as represented by view 300 in FIG. 7 can similarly be applied to a variety of entities associated with a process of interest, or with a product or other entity of interest apart from a process of interest. FIG. 8A is an exemplary product view providing sentiment information regarding a variety of attributes associated with a product. As shown, the view 400 includes a product-identifying graphic 410 identifying a product of interest. The view 400 further includes a plurality of attribute-identifying graphics 412-420. Similar to the entity-identifying graphics 312-320 of FIG. 7A, each of the attribute-identifying graphics 412-420 include a first area 430 and a second area 432 as shown in FIG. 8B, and are presented in different sizes. Such display characteristics can be representative of similar properties as described above with regard to FIGS. 7A-7B. For example, the relative size of the first 430 and second 432 areas can represent the relative amount of positive and negative sentiment associated with each attribute. Additionally, the relative size of each attribute-identifying graphic 412-420 can represent a relative number of identified phrase features providing sentiment analysis regarding each particular attribute.

It will be appreciated that attributes, such as shown in attribute-identifying graphics 412-420, need not be associated exclusively with products. In general, attributes can be descriptive of a product of interest, any entity of a process of interest, or of a process of interest. Accordingly, attribute-identifying graphics such as 412-420 are not limited to product views such as 400, but can be present in any appropriate view (e.g., process view, entity view, etc.). In some examples, a view can include both entity-identifying graphics (e.g., 312-320) and attribute-identifying graphics (e.g., 412-420) corresponding to various entities and attributes associated with a particular process, product, or other entity identified in an identifying graphic such as 310 or 410.

In some embodiments, views such as 300 in FIG. 7A and 400 in FIG. 8A can be linked, for example, via a hierarchy. For instance, a first level of a hierarchy might include the process 310, with entities shown in entity-identifying graphics 312-320 being at a second, lower level of the hierarchy. Product 410 of FIG. 8A might be one of the entities (e.g., first entity 312) represented by entity-identifying graphics 312-320, and may be positioned at the second level in the hierarchy. Attributes represented by attribute-identifying graphics 412-420 and associated with the product 410 can be positioned at a third level of the hierarchy, the third level being lower than the second. Thus, in some examples, a user may initially observe view 300 via interface 130, and select the first entity-identifying graphic 312 to select the first entity via the interface 130. Selection of the first entity may generate view 400 to provide more details regarding various attributes associated with the first entity. In general, various processes, entities, and attributes may be linked via hierarchies, facilitating a user's ability to drill down into details regarding the sentiment of various components of a product or process via a convenient interface 130.

In some examples, system 100 can be configured to operate in substantially real time. In various embodiments, the system 100 can be configured to collect plain text data 150 from one or more plain text repositories 250 on a period basis (e.g., hourly, daily, weekly, monthly, etc.). In some examples, the frequency at which the system searches for and acquires plain text data can be defined by a user. In some examples, the system 100 can be in communication with plain text repository 250 such that the system 100 is alerted when new plain text data is contributed to the repository 250. The system 100 can immediately analyze the newly-contributed plain text data and update relevant sentiment analysis stored in the data manager.

Thus, in various embodiments, views such as 300 as shown in FIG. 7A or 400 as shown in FIG. 8A may be dynamically generated and updated as often as the system 100 acquires additional plain text data relevant to the view. With exemplary reference to FIGS. 7A and 7B, additional available plain text data may result in a change of the relative size of the first area 330 to the second area 332 if additional phrase features regarding an existing entity (e.g., the first entity) are determined. Additionally or alternatively, additional available plain text data may result in the addition of a new entity-identifying graphic to the view with relative size and first and second areas as described above.

In some embodiments, views such as 300 or 400 can be generated or presented to a user in response to prompts by the user. For example, a user may select a process or product (or other entity) of interest from a database of available processes. In some embodiments, the user can drill down into various aspects of the process, for example, using hierarchies 214 such as those defined in entity manager 104. For instance, in some examples, a user can select a process of interest, and subsequently select an entity of the process as a new process of interest. The entity can have a variety of associated entities (e.g., located a tier below the selected entity in a hierarchy) which can be analyzed and displayed in a view such as that in FIG. 7. Accordingly, in some embodiments, users may drill down into processes of interest to analyze sentiment of a variety of entities at various levels of the process.

In some examples, a user can search for data associated with a process of interest via a plain text query tool. The system can perform NLP on a user-entered plain text search to find and display sentiment analysis of entities associated with the user-entered plain text search. In some embodiments, the plain text query tool can find analyzed processes or entities based on stored entity information 212 or information in the acquisition manager 102. In some examples, the system can recognize words of phrases associated with such analyzed processes or entities and generate a view based on a search of such associated words of phrases.

In some embodiments, the system 100 can be configured to perform predictive sentiment analysis for a product or process yet to be analyzed. For example, the system 100 can determine (e.g., by machine learning, NLP, user definition, etc.) an association between multiple entities, attributes, or processes. Such associations can be used to predict sentiment of an unanalyzed entity or process based on sentiment analysis of an associated entity or process without requiring sentiment analysis of plain text data associated with the unanalyzed entity or process.

### EXAMPLE 1

In an exemplary embodiment, a process of interest might include the online purchasing of a pair of shoes. In such an embodiment, the acquisition manager 102 can be directed to retail websites that sell shoes or websites of companies who sell or manufacture shoes. In some such examples, the acquisition manager 102 can be directed to specific portions of the website, such as product descriptions, customer reviews, etc. The acquisition manager 102 can additionally or alternatively be directed to social media websites on which users may comment or post other content related to shoes. In general, the acquisition manager 102 can be directed to any desired repository 250. In some examples, the system 100 can receive direction (e.g., via data manager 120) to define the scope of the acquisition manager 102. The acquisition manager 102 can search for unstructured, plain text data from the repository 250, and analyze the plain text data to find information related to the online purchasing of a pair of shoes and extract such plain text data for analysis at A.

In such an example, the entity manager 104 can include a variety of entity information 212 regarding possible entities associated with the process. For example, entity information 212 can include types or brands of shoes, various features of a shoe, or aspects related to a purchasing process, the shipping process, customer service, or any other step, actor, item, or other dimension associated with the process of buying shoes online.

Such entity information 212 can be arranged into various hierarchies 214. For instance, a tier of a hierarchy can include a specific type of shoe, while a lower tier can include brands of shoes associated with a particular type of shoe. In another exemplary hierarchy, one tier can include a brand of shoes, while a lower tier can include types of shoes associated with that particular brand. That is, in some examples, various entities in the entity information can have a variety of relationships to one another in different hierarchies.

The entity manager 104 can apply the entity information 212 to the acquired text 216 received at A. For instance, the entity manager 104 can recognize the occurrence of various entities in the acquired text 216 such as brands of shoes or steps (e.g., shopping, shipping, purchasing) in the process of buying shoes, and apply appropriate entity information 212 to the acquired text 216 for output at B.

The language manager 106 can receive the text with associated entity information 212 at B and perform NLP analysis 220. The language manager 106 can be configured to apply customized grammar 222 on the text to generate phrase features 224. The phrase features 224 can include an entity of the shoe-buying process and a sentiment regarding that entity. For instance, exemplary generated phrase features 224 can include statements such as “the shipping was slow,” “customer service was helpful,” the shoe is comfortable,” “this brand is reliable,” and so on. The application of the customized grammar 222 and the generation of phrase features 224 can be output at C.

The event manager 108 can receive the processed text and assign phrase features to the entities of the process. For example, the event manager may receive the phrase feature “the customer service was helpful” and assign the phrase feature to the customer service dimension of the process of buying shoes. That is, while the language manager 106 identified the phrase feature that included the customer service dimension, the event manager 108 can assign the phrase feature to the entity. It will be appreciated that in some embodiments, the functionality of the language manager 106 can be built in to the event manager 108, or vice versa, resulting in a single manager configured to perform steps associated with both the language manager 106 and the event manager 108. Operation of the event manager 108 can be based on machine learning engine 230. Phrase features can be assigned 232 to appropriate entities by the event manager 108 can be output at D.

The phrase features having associated entities can be received by the process manager 110 at D and associated 240 with a process. For instance, the phrase feature “the customer service was helpful” assigned to the customer service dimension can be assigned to the process of buying shoes online. In some examples, each entity can be assigned to multiple processes. For example, if the phrase feature “the customer service was helpful” applies to a company associated with manufacturing or selling not only shoes, but pants as well, such a phrase feature can be applied to both processes of buying shoe and of buying pants. In some examples, determination of which entities apply to which processes can be determined from overlapping hierarchies as defined by the entity manager 104.

The process manager 110 can perform sentiment analysis 242 on the phrase features, determining whether a phrase feature includes positive, negative, or neutral sentiment regarding the entity mentioned in the phrase feature. For instance, the process manager 110 can determine that the phrase feature “the customer service was helpful” includes positive sentiment regarding the customer service dimension of the process of buying shoes. In general, the process manager 110 can manage 224 the assignment of sentiment from phrase features to associated entities, and the assignment of entities to processes. The process manager 110 can output such data to the data manager 120

The data manager 120 can store information generated by the process manager 110 in memory 122. The data manager 120 can provide a view for a user to customize or define various aspects of the system 100, such as defining entity information or data acquisition parameters. For instance, the data manager 120 can receive and store acquisition parameters directing the acquisition manager 102 toward a particular blog or retail website focusing on shoes to acquire plain text data as designated by a user. The data manager 120 can further receive entity information 212 for the entity manager 104 to differentiate between particular types of shoe (e.g., running shoes and sandals).

The data manager 120 can further be configured to generate a view that can be used to observe analyzed sentiment data, for instance in the form of the view 300 shown in FIG. 7A. For example, the view 300 can include the process 310 of buying shoes, and entities such as the shoe itself (e.g., 312), the purchasing view (e.g., 314), the shopping experience (e.g., 316), customer service (e.g., 318), and the shopping experience (e.g., 320). As discussed with regard to FIG. 7, the view can provide information such as the relative sentiment of each entity associated with the shoe-buying process, as well the relative number of phrase features acquired corresponding to each entity.

### EXAMPLE 2

In another exemplary embodiment, a product of interest might include a pair of shoes. In such an embodiment, the acquisition manager 102 may function similarly to that described with regard to Example 1 above to acquire plain text data related to shoes. The entity manager 104 can include entity information 121 associated with shoes, such as types or brands of shoes, various features of a shoe, or other attributes associated with shoes, such as size, color, comfort, style, etc. The entity information 212 can be arranged into a variety of hierarchies 214. For example, one tier of the hierarchy might include a type of shoe, while a lower tier of the hierarchy can include any of a variety of attributes associated with that type of shoe.

The entity manager 104 can apply entity information 212 to the acquired text received at A. For instance, the entity manager 104 can recognize the occurrence of various attributes of shoes in the acquired text 216 such as type, price, style, comfort, etc., and apply appropriate entity information 212 to the acquired text 216 for output at B.

The language manager 106 can receive the text with associated entity information 212 at B and perform NLP analysis 220. The language manager 106 can be configured to apply customized grammar 222 on the text to generate phrase features 224. The phrase features 224 can include an attribute of a particular pair of shoes and a sentiment regarding that attribute. For instance, exemplary generated phrase features 224 can include statements such as “the shoes are comfortable” “the color is ugly,” the shoe is overpriced,” “this brand is reliable,” and so on. The application of the customized grammar 222 and the generation of phrase features 224 can be applied and can be output at C.

The event manager 108 can receive the processed text and assign phrase features to the attributes of the product. For example, the event manager 108 may receive the phrase feature “the shoes are comfortable” and assign the phrase feature to the comfort attribute of the product. That is, while the language manager 106 identified the phrase feature that included the attribute, the event manager 108 can assign the phrase feature to the attribute. Phrase features can be assigned 232 to appropriate attributes by the event manager 108 can be output at D.

The phrase features having associated attributes can be received by the process manager 110 at D and associated 240 with a product. For instance, the phrase feature “the shoes are comfortable” assigned to the comfort attribute can be assigned to the product of a pair shoes. In some examples, each attribute can be assigned to multiple products. For example, if the phrase feature “the shoes are comfortable” applies to a company associated with manufacturing or selling many types of shoes, such a phrase feature can be applied to multiple shoe products associated with that company. In some examples, determination of which attributes apply to which products can be determined from overlapping hierarchies 214 as defined by the entity manager 104.

The process manager 110 can perform sentiment analysis 242 on the phrase features, determining whether a phrase feature includes positive, negative, or neutral sentiment regarding the attribute mentioned in the phrase feature. For instance, the process manager 110 can determine that the phrase feature “the shoes are comfortable” includes positive sentiment regarding the comfort attribute of the product. In general, the process manager 110 can manage 224 the assignment of sentiment from phrase features to associated attributes, and the assignment of attributes to products. The process manager 110 can output such data to the data manager 120

The data manager 120 can store information generated by the process manager 110 in memory 122. The data manager 120 can provide a view for a user to customize or define various aspects of the system 100, such as defining entity information 212 or data acquisition parameters. For instance, the data manager 120 can receive and store acquisition parameters directing the acquisition manager 102 toward a particular blog or retail website focusing on shoes to acquire plain text data as designated by a user. The data manager 120 can further receive entity information 212 for the entity manager 104 to differentiate between particular types of shoe (e.g., running shoes and sandals).

The data manager 120 can further be configured to generate a view that can be used to observe analyzed sentiment data, for instance in the form of the view 400 shown in FIG. 8A. For example, the view 400 can include the product 410 of a pair of shoes, and attributes such as style (e.g., 312), comfort (e.g., 314), price (e.g., 316), durability (e.g., 318), and fit (e.g., 320). As discussed with regard to FIG. 8, the view can provide information such as the relative sentiment of each attribute associated with the shoe-buying process, as well the relative number of phrase features acquired corresponding to each attribute.

In general, many other processes, products, or types of processes, products, or other entities may be similarly analyzed. Such analysis can be useful from a variety of perspectives associated with a variety of views representative of acquired data. Other processes can include, but are not limited to, retail shopping, help desk support, software usability, loan processing, consumer banking, government/public services, medical services, etc. Exemplary processes can include steps such as receiving a service (e.g., a commercial service or a government service from a consumer's perspective) or working with a particular supplier (e.g., from a manufacturer's perspective). Any of a variety of products having corresponding attributes may be similarly analyzed.

It will be appreciated that any process or product may include entities or attributes about which parties associated with the process or product may express sentiment. Embodiments of the system can generally capture the sentiment associated with various entities or attributes of the process or product and generate a view by which a user can observe such sentiment on an entity-by-entity or attribute-by-attribute basis. In some examples, a user can simultaneously observe relative sentiment of both entities and attributes associated with a process or product. Further, the entities and attributes for which sentiment is presented to a user may vary based on the user's role in the process or relationship to the product of interest, or may be customized by the user.

Various system and examples have been described. The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “controller” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a non-transitory computer-readable medium, such as a computer-readable storage medium, containing instructions. Instructions embedded or encoded in a computer-readable storage medium may cause a programmable processor, or other processor, to perform the method, e.g., when the instructions are executed. Non-transitory computer readable storage media may include volatile and/or non-volatile memory forms including, e.g., random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various embodiments have been described. Such examples are non-limiting, and do not define or limit the scope of the invention in any way. Rather, these and other examples are within the scope of the following claims:

1. A system for analyzing customer sentiment of one or more products or processes, each product or process comprising one or more attributes or entities, the system comprising:
an acquisition manager configured to acquire plain text data regarding one or more of the one or more products or processes from one or more predetermined sources;
an entity manager configured to store entity information regarding one or more attributes or entities related to at least one of the one or more products or processes and to assign at least one of attribute and entity information to the acquired plain text data;
a language manager configured to analyze the acquired plain text data by: (i) performing natural language processing (NLP) on the acquired plain text data, (ii) assigning customized grammar to the acquired plain text data, and (iii) generating phrase features by breaking the acquired plain text data into isolated fragments indicating one or more of a single sentiment and a single attribute or entity associated with at least one of the one or more products or processes;
an event manager configured to assign each of the generated phrase features of the acquired plain text data to a single attribute or entity of one of the one or more products or processes; and
a process manager configured to assign each attribute or entity and the associated phrase features of the acquired plain text data to at least one corresponding products or processes and perform sentiment analysis regarding each attribute or entity of the one or more products or processes.

2. The system of claim 1, wherein entity information comprises information regarding any combination of: one or more products related to a process, one or more attributes associated with one or more products, one or more steps in the process, or an actor performing one or more steps in a process.

3. The system of claim 2, wherein at least one product comprises an item for sale, and wherein at least one associated process comprises a process of shopping for the item.

4. The system of claim 3, wherein the process of shopping for the item comprises steps selected from one or more of: a shopping activity, a purchasing activity, a customer service activity, a shipping activity, a delivery activity, a buyer activity, and an item activity.

5. The system of claim 2, wherein
the language manager is further configured to generate phrase features including a sentiment and an attribute separate from a step in the process, the attribute including one of a buyer satisfaction dimension and a product quality dimension;
the event manager is configured to assign phrase features including the attribute to the attribute; and
the process manager is further configured to perform sentiment analysis regarding each attribute.

6. The system of claim 2, wherein the entity manager is pre-loaded with a database of products associated with at least one of one or more processes.

7. The system of claim 2, wherein at least one product comprises a service provided by a party, wherein sentiment regarding at least one step of one or more processes associated with the service comprises the effectiveness of the provided service.

8. The system of claim 2, further comprising a data manager configured to store data from the process manager, the data comprising a hierarchy including one or more products, one or more attributes associated with at least one of the one or more products, one or more processes associated with at least one of the one or more products, one or more steps included in at least one of the one or more processes, and sentiment analysis of at least one of the one or more steps, the one or more products, and the one or more attributes.

9. The system of claim 8, wherein the data manager further comprises data related to one or more of: (i) product definitions, (ii) process and step definitions, (iii) acquisition parameters, and (iv) language parameters.

10. The system of claim 9, further comprising an interface to the data manager by which a user can access the hierarchy to view sentiment analysis regarding multiple levels of the hierarchy.

11. The system of claim 2, further comprising a machine learning engine associated with at least the event manager and the process manager, the machine learning engine configured generate the phrase features of the acquired plain text data and to assign the generated phrase features to at least one entity of one of the one or more processes or at least one attribute of the one or more products based on a machine learning process.

12. The system of claim 1, further comprising a forecast manager, the forecast manager configured to receive details of a first attribute or entity, recall sentiment information regarding one or more like attributes or entities, the like attributes or entities having one or more like details of the first attribute or entity, and forecast sentiment information regarding the first attribute or entity based on the recalled sentiment information of the one or more like attributes or entities.

13. A method for determining sentiment related to one or more separate steps of a process or one or more attributes of a product comprising:
acquiring plain text data from one or more predetermined sources, the plain text data including indeterminate sentiment information regarding one or more steps in the process or attributes of the product;
performing natural language processing (NLP) on the acquired plain text data;
separating the acquired plain text data into phrase features based on the performed NLP, each of the phrase features being associated with a single step of the process or a single attribute of the product;
assigning each of the phrase features to its associated step of the process or attribute of the product;
performing sentiment analysis on each of the phrase features assigned to each of the associated steps or attributes;
determining an overall sentiment of each separate step of the process or attribute of the product; and
generating and displaying a graphical representation of the sentiment of each step of the process or each attribute of the product.

14. The method of claim 13, wherein assigning each of the phrase features to the associated step of the process or attribute of the product includes selecting and executing a machine learning process by a machine learning engine configured to process the separated phrase features and determine the step in the process or attribute of the product associated with each phrase feature.

15. The method of claim 14, further comprising the step of teaching the machine learning engine to identify a step or an attribute and a sentiment associated with each phrase feature.

16. The method of claim 13, further comprising the step of assigning at least one of attribute information and entity information to the acquired plain text data.

17. The method of claim 16, wherein the process or product comprises the process of purchasing a product; and
the separate steps of the process include at least one of a shopping activity, a customer service activity, a shipping activity, a buyer activity, and an item activity.

18. The method of claim 16, further comprising defining the predetermined source from which plain text data is acquired and identifying attribute or entity information for assigning to acquired plain text data.

19. The method of claim 13, further comprising:
receiving one or more descriptions regarding a future process;
associating the one or more descriptions with one or more steps in an existing like process; and
forecasting sentiment of one or more aspects of the future process based on sentiment analysis of the one or more steps in the existing like process.

20. The method of claim 13, further comprising:
receiving one or more descriptions regarding an unanalyzed product;
associating the one or more descriptions with one or more attributes of an existing like product; and
forecasting sentiment of one or more aspects of the unanalyzed product based on sentiment analysis of the one or more attributes in the existing like product.

21. The method of claim 13, further comprising:
identifying phrase features describing an attribute of a process or product, the attribute being separate from a step in the process or product;
assigning the identified phrase features to the described attribute; and
performing sentiment analysis on the phrase features assigned to the attribute of the process or product.

22. A method for displaying relative customer sentiment of two or more steps in a process or attributes of a product comprising:
acquiring plain text data from a predetermined source regarding one or more of the two or more entities or attributes associated with the process or product;
generating, from the acquired plain text data, sentiment data corresponding to each entity associated with the process or each attribute associated with the product;
displaying a process-identifying graphic identifying the process or a product-identifying graphic identifying the product; and
displaying two or more (i) entity-identifying graphics associated with the process-identifying graphic or (ii) attribute-identifying graphics associated with the product-identifying graphic, each entity-identifying graphic a unique one of the two or more entities associated with the process or each attribute-identifying graphic corresponding to a unique one of the two or more attributes associated with the product; wherein
each entity-identifying graphic or attribute-identifying graphic includes information regarding the sentiment associated with the identified entity or attribute and the relative strength of the sentiment.

23. The method of claim 22, wherein generating, from the acquired plain text data, sentiment data corresponding to each entity or attribute in the process comprises:
separating the acquired plain text data into phrase features and assigning each phrase feature to an associated entity of the process or attribute of the product; and
performing sentiment analysis on each of the phrase features assigned to each of the associated entities or attributes.

24. The method of claim 23, wherein each entity-identifying graphic or attribute-identifying graphic further includes information regarding the overall number of phrase features assigned to each identified entity or attribute.

25. The method of claim 24, wherein:
each entity-identifying graphic or attribute-identifying graphic comprises a first area and a second area, the second area being visibly distinguishable from the first and the relative size of the first area to the second area being indicative of the relative amount of positive sentiment to negative sentiment associated with the identified entity or attribute; and
the size of each entity-identifying graphic or attribute-identifying graphic corresponds to the number of phrase features from the acquired plain text data associated with the identified entity or attribute; such that
displaying the relative strength of the sentiment comprises displaying (i) the proportion of positive sentiment to negative sentiment and (ii) the relative number of analyzed phrase features associated with each identified entity or attribute.

26. The method of claim 22, wherein two or more entity-identifying graphics include at least one step-identifying graphic corresponding to a step in the process and at least one dimension-identifying graphics corresponding to a dimension associated with the process and being separate from steps associated with the process.
